(19) United States
(12) Patent Application Publication
(10) Pub. No.: US 2024/0429458 A1
(43) Pub. Date: Dec. 26, 2024

(54) ALL-SOLID-STATE BATTERY, AND APPARATUS AND METHOD FOR MANUFACTURING ALL-SOLID-STATE BATTERY

(71) Applicant: Samsung SDI Co., Ltd., Yongin-si, Gyeonggi-do (KR)

(72) Inventors: Man Soo SHIN, Yongin-si (KR); Jeong Hoon KIM, Yongin-si (KR); Jin Uk HONG, Yongin-si (KR)

(21) Appl. No.: 18/699,244

(22) PCT Filed: Oct. 6, 2022
(86) PCT No.: PCT/KR2022/015052

§ 371 Date: Apr. 5, 2024

(30) Foreign Application Priority Data
Oct. 7, 2021 (KR) 10-2021-0133258
Oct. 7, 2021 (KR) 10-2021-0133259

(51) Int. Cl. H01M 10/0585; B21D 28/14; H01M 10/0562

(52) U.S. Cl. CPC H01M 10/0585; B21D 28/14; H01M 10/0562; H01M 2300/0068

(57) ABSTRACT

An embodiment of the present invention relates to an all-solid-state battery and an apparatus and method for manufacturing the all-solid-state battery. According to an embodiment of the present invention, a pressing process is performed in a state in which plate-shaped materials and die molds accommodating the plate-shape materials are accommodated in an outer punch mold, and thus it is possible to dry-press a plurality of the plate-shaped materials. Therefore, it is possible to simplify the process of dry-pressing the plate-shaped materials and shorten the required process time.

### TECHNICAL FIELD

Embodiments of the present invention relate to an all-solid-state battery and an apparatus and method for manufacturing an all-solid-state battery.

### BACKGROUND ART

In response to recent industrial needs, batteries with higher energy density and safety have been actively developed. An all-solid-state battery, in which a positive electrode, a solid electrolyte, and a negative electrode are laminated and pressed so as to be densified, uses the solid electrolyte instead of an electrolyte solution used in general secondary batteries.

All-solid-state batteries are manufactured using either a wet isostatic pressing method or a dry isostatic pressing method. The wet isostatic pressing method suffers from low productivity due to the complexity of the sealing and unsealing in a wet process. In developing all-solid-state batteries, therefore, the dry isostatic pressing method is also gaining attention. An example of a manufacturing method based on the dry isostatic pressing method is disclosed in U.S. Pat. No. 5,490,969 (registered on Feb. 13, 1996). However, the manufacturing method disclosed in the above prior art document is suitable for pressing a cylindrical product, and therefore it is desirable to develop a new manufacturing method for producing a plate-shaped all-solid-state battery.

The above information disclosed in this Background Art section is only for enhancement of understanding of the background of the present invention and therefore it may contain information that does not form the prior art.

### DISCLOSURE

### Technical Problem

Embodiments of the present invention provide an all-solid-state battery and an apparatus and method for manufacturing an all-solid-state battery.

### Technical Solution

Embodiments of the present invention provide an apparatus for manufacturing an all-solid-state battery, the apparatus including a pressure vessel having a receiving space defined therein, the receiving space being configured to receive a medium, a pair of closing covers configured to open and close the pressure vessel, an outer punch configured such that a part or the entirety of the outer punch is received in the pressure vessel, and a die configured to be inserted into the outer punch in the state in which a plurality of sheet materials is received therein, wherein a surface of each of the sheet materials, a plate surface of the die in which the sheet materials are received, and a plate surface of the outer punch in which the die is received are parallel to each other, the outer punch is disposed such that an outside of the outer punch is in contact with the medium, and the die is disposed between the outer punch and the closing covers so as not to be in contact with the medium.

The outer punch may include a disc-shaped base plate and a die receiving portion formed so as to extend from the base plate in a plate shape, the die receiving portion being configured to receive the die.

The die may include a die plate having a plurality of intaglio portions concavely formed in a plate surface thereof, the intaglio portions being configured to allow the sheet materials to be inserted thereinto, a die pad configured to support the die plate, and a fixing film coupled to the die plate in the state in which the sheet materials are inserted into the intaglio portions, the die plate being inserted into the die receiving portion.

The apparatus may further include a disc-shaped ejecting plate having a through-hole formed therethrough, the through-hole being configured to allow the die plate to be inserted therethrough, wherein the ejecting plate may be disposed between the base plate of the outer punch and the die pad of the die.

The ejecting plate may include a cut portion formed in a surface thereof facing the die pad, the cut portion being cut so as to have a shape corresponding to the shape of the die pad.

The pressure vessel may have a cylindrical shape, and the pressure vessel may include a pressing portion configured to receive the medium and cover insertion portions formed at opposite ends of the cylindrical shape, the cover insertion portions communicating with the pressing portion, the cover insertion portions being configured to allow the closing covers to be coupled thereto.

The inner diameter of the pressing portion may be less than the diameter of each of the closing covers, and the diameter of each of the base plate and the ejecting plate may correspond to the diameter of each of the closing covers.

The inner diameter of the pressing portion may be greater than the diameter of each of the closing covers, the diameter of the base plate may correspond to the inner diameter of the pressing portion, and the diameter of the ejecting plate may correspond to the diameter of each of the closing covers.

The apparatus may further include a support unit including a compensation portion disposed under the pressure vessel, the compensation portion being configured to push the closing cover toward the pressure vessel during a pressing process, a support block disposed above the pressure vessel, and a support portion configured to support the compensation portion and the support block.

The compensation portion may include a moving block disposed under the closing cover, a guide block disposed under the moving block, the guide block being configured to support the moving block, a support fixture coupled to the guide block, the support fixture being configured to support the guide block, an insertion bolt rotatably installed at one side of the support fixture, the insertion bolt being configured to move the moving block in one direction, and a withdrawal bolt rotatably installed at the other side of the support fixture so as to be opposite the insertion bolt, the withdrawal bolt being configured to move the moving block in a direction toward the insertion bolt.

An upper surface or a lower surface of the moving block may be inclined, and the height of the moving block may gradually decrease from an end toward the insertion bolt to an end toward the withdrawal bolt.

An upper surface of the guide block may be inclined, and the height of the guide block may gradually increase from an end toward the insertion bolt to an end toward the withdrawal bolt.

Embodiments of the present invention provide a method of manufacturing an all-solid-state battery, the method including inserting a sheet material into each of a plurality of intaglio portions of a die plate and coupling a fixing film to the die plate, inserting the die plate into a die receiving portion of an outer punch, inserting the outer punch into a pressure vessel and inserting a lower closing cover into a lower part of the pressure vessel so as to be in tight contact with a base plate of the outer punch and an ejecting plate, filling the pressure vessel with a medium in the state in which an upper closing cover and the lower closing cover are inserted into the pressure vessel and further pumping the medium through a pipe separately connected to the pressure vessel or to the closing cover to perform pressing, and moving a moving block to bring the lower closing cover into tight contact with the pressure vessel and performing a pressing process.

In the step of performing pressing, the moving block may be moved by a displacement of the lower closing cover pushed by pressure during pressing in order to compensate for the displacement.

A surface of the sheet material, a plate surface of the die plate in which the sheet material is received, and a plate surface of the die receiving portion in which the die is received may be parallel to each other.

The outer punch may be disposed such that an outside of the outer punch is in contact with the medium, and the die may be disposed between an inside of the outer punch and the closing covers so as not to be in contact with the medium.

Embodiments of the present invention provide an all-solid-state battery manufactured using the method described above.

Embodiments of the present invention provide an apparatus for manufacturing an all-solid-state battery, the apparatus including a pressure vessel having a receiving space defined therein, the receiving space being configured to receive a medium, a pair of closing covers configured to open and close the pressure vessel, an outer punch configured such that a part or the entirety of the outer punch is received in the pressure vessel, the outer punch including a base plate and a plurality of die receiving portions formed so as to extend from the base plate in a plate shape, each of the die receiving portions being configured to receive a die, and a plurality of dies configured such that each of the dies is inserted into a corresponding one of the die receiving portions in the state in which a plurality of sheet materials is received therein, wherein a surface of each of the sheet materials, a plate surface of the die in which the sheet materials are received, and a plate surface of the outer punch in which the die is received are parallel to each other, the outer punch is disposed so as to be in contact with the medium, and the die is disposed between the outer punch and the closing covers so as not to be in contact with the medium.

The plurality of die receiving portions may be disposed spaced apart from each other so as not to overlap each other.

The die may include a die plate having a plurality of intaglio portions concavely formed in a plate surface thereof, the intaglio portions being configured to allow the sheet materials to be inserted thereinto, a die pad configured to support the die plate, and a fixing film coupled to the die plate in the state in which the sheet materials are inserted into the intaglio portions, the die plate being inserted into the die receiving portion.

The apparatus may further include a disc-shaped ejecting plate having a plurality of through-holes formed therethrough, each of the through-holes being configured to allow the die plate to be inserted therethrough, wherein the ejecting plate may be disposed between the base plate of the outer punch and the die pad of the die.

The ejecting plate may include a cut portion formed in a surface thereof facing the die pad, the cut portion being cut so as to have a shape corresponding to the shape of the die pad.

The pressure vessel may have a cylindrical shape, and the pressure vessel may include a pressing portion configured to receive the medium and cover insertion portions formed at opposite ends of the cylindrical shape, the cover insertion portions communicating with the pressing portion, the cover insertion portions being configured to allow the closing covers to be coupled thereto.

The inner diameter of the pressing portion may be less than the diameter of each of the closing covers, and the diameter of each of the base plate and the ejecting plate may correspond to the diameter of each of the closing covers.

The apparatus may further include a support unit including a compensation portion disposed under the pressure vessel, the compensation portion being configured to push the closing cover toward the pressure vessel during a pressing process, a support block disposed above the pressure vessel, and a support portion configured to support the compensation portion and the support block.

The compensation portion may include a moving block disposed under the closing cover, a guide block disposed under the moving block, the guide block being configured to support the moving block, a support fixture coupled to the guide block, the support fixture being configured to support the guide block, an insertion bolt rotatably installed at one side of the support fixture, the insertion bolt being configured to move the moving block in one direction, and a withdrawal bolt rotatably installed at the other side of the support fixture so as to be opposite the insertion bolt, the withdrawal bolt being configured to move the moving block in a direction toward the insertion bolt.

An upper surface or a lower surface of the moving block may be inclined, and the height of the moving block may gradually decrease from an end toward the insertion bolt to an end toward the withdrawal bolt.

An upper surface of the guide block may be inclined, and the height of the guide block may gradually increase from an end toward the insertion bolt to an end toward the withdrawal bolt.

Embodiments of the present invention provide a method of manufacturing an all-solid-state battery, the method including inserting a sheet material into each of a plurality of intaglio portions of a die plate and coupling a fixing film to the die plate, inserting the die plate into each of a plurality of die receiving portions of an outer punch, inserting the outer punch into a pressure vessel and inserting a lower closing cover into a lower part of the pressure vessel so as to be in tight contact with a base plate of the outer punch and an ejecting plate, filling the pressure vessel with a medium in the state in which an upper closing cover and the lower closing cover are inserted into the pressure vessel and further pumping the medium through a pipe separately connected to the pressure vessel or to the closing cover to perform pressing, and moving a moving block to bring the lower closing cover into tight contact with the pressure vessel and performing a pressing process.

A surface of the sheet material, a plate surface of the die plate in which the sheet material is received, and a plate surface of the die receiving portion in which the die is received may be parallel to each other.

The outer punch may be disposed so as to be in contact with the medium, and the die may be disposed between the outer punch and the closing covers so as not to be in contact with the medium.

In the step of performing the pressing process, the moving block may be moved by a displacement of the lower closing cover pushed by pressure during pressing in order to compensate for the displacement.

Embodiments of the present invention provide an all-solid-state battery manufactured using the method described above.

### Advantageous Effects

According to embodiments of the present invention, a pressing process is performed in the state in which a sheet material and a die configured to receive the sheet material are received in an outer punch, and therefore it is possible to press the sheet material in a dry state. Consequently, it is possible to eliminate or simplify pre- and post-processes such as the use of a packaging-related envelope material, vacuum, drying, and unpacking, which are performed in order to prevent contact between the sheet material and a medium. As a result, the process material cost may be reduced, the dry pressing process of the sheet material may be simplified, and the process time may be shortened, resulting in a lower manufacturing cost of the pressing process.

In addition, according to embodiments of the present invention, pushing of a closing cover may be prevented during the pressing process, whereby it is possible to prevent deformation and fatigue damage of the die, which may further contribute to reduction in the manufacturing cost in the pressing process by reducing maintenance costs such as extending the lifespan of parts of pressing equipment.

### DESCRIPTION OF DRAWINGS

FIG. 1 is a forward sectional view showing an apparatus for manufacturing an all-solid-state battery according to an embodiment of the present invention.

FIG. 2 is a lateral sectional view showing the apparatus for manufacturing the all-solid-state battery according to the embodiment of the present invention.

FIG. 3 is a sectional view showing a manufacturing unit of the apparatus for manufacturing the all-solid-state battery according to FIGS. 1 and 2.

FIG. 4 is an exploded perspective view showing main parts of the apparatus for manufacturing the all-solid-state battery according to FIG. 3.

FIG. 5 is a cut perspective view showing an outer punch according to FIG. 4.

FIG. 6 is a coupled perspective view showing an ejecting plate and a die according to FIG. 4.

FIG. 7 is a cut perspective view of the ejecting plate and the die according to FIG. 6.

FIG. 8 is an exploded perspective view of the die according to FIG. 4.

FIG. 9 is a sectional view of the die according to FIG. 8.

FIG. 10 is a sectional view of the ejecting plate and the die according to FIG. 6.

FIG. 11 is a schematic view showing the direction of pressure applied to the main parts according to FIG. 3.

FIG. 12 is a sectional view showing main parts of an apparatus for manufacturing an all-solid-state battery according to another embodiment of the present invention.

FIG. 13 is a schematic view showing a part of a manufacturing unit according to FIG. 3.

FIG. 14 is a schematic view showing a part of a manufacturing unit according to FIG. 12.

FIG. 15 is a schematic view showing a part of a support unit according to FIGS. 1 and 2.

FIG. 16 is a schematic view showing an operating principle of the support unit according to FIGS. 1 and 2.

FIG. 17 is a forward sectional view showing an apparatus for manufacturing an all-solid-state battery according to an embodiment of the present invention.

FIG. 18 is a lateral sectional view showing the apparatus for manufacturing the all-solid-state battery according to the embodiment of the present invention.

FIG. 19 is a sectional view showing a manufacturing unit of the apparatus for manufacturing the all-solid-state battery according to FIGS. 17 and 18.

FIG. 20 is an exploded perspective view showing main parts of the apparatus for manufacturing the all-solid-state battery according to FIG. 19.

FIG. 21 is a cut perspective view showing a part of an outer punch according to FIG. 20.

FIG. 22 is a perspective view showing an ejecting plate according to FIG. 20.

FIG. 23 is an exploded perspective view of a die according to FIG. 20.

FIG. 24 is a partial sectional view of the die according to FIG. 23.

FIG. 25 is a partial sectional view of the die and the outer punch according to FIG. 20.

FIG. 26 is a schematic view showing the direction of pressure applied to the main parts according to FIG. 19.

### BEST MODE

Embodiments of the present invention are provided to more fully illustrate the present invention to a person having ordinary skill in the art to which the present invention pertains, the following embodiments may be modified in various other forms, and the scope of the present invention is not limited to the following embodiments. The embodiments are provided to make the disclosure more faithful and complete and to completely convey the idea of the present invention fully to those skilled in the art.

Also, in the following drawings, the thickness or size of each layer is exaggerated for convenience and clarity of description and the same reference symbols in the drawings refer to the same elements. As used herein, the term “and/or” includes any one of the enumerated items and any combination of one or more thereof. In addition, as used herein, the term “connected” refers not only to direct connection between members A and B but also to indirect connection between members A and B with member C interposed between members A and B.

The terms used in the specification are intended to describe specific embodiments and are not intended to limit the present invention. As used herein, singular forms may include plural forms, unless the context clearly indicates otherwise. In addition, as used herein, the terms “comprise” (or “include”) and/or “comprising” (or “including”) are intended to specify the presence of stated figures, numbers, steps, operations, members, elements, and/or groups thereof and do not exclude the presence or addition of one or more other figures, numbers, steps, operations, members, elements, and/or groups.

While terms such as first and second are used herein to describe various members, parts, regions, layers, and/or portions, the members, the parts, the regions, the layers, and/or the portions are not to be limited by the terms. The terms are used only to distinguish one member, one part, one region, one layer, or one portion from another member, another part, another region, another layer, or another portion. Thus, a first member, a first part, a first region, a first layer, or a first portion hereinafter described may refer to a second member, a second part, a second region, a second layer, or a second portion without departing from the teachings of the disclosure.

Terms related to space, such as “beneath,” “below,” “lower,” “above,” and “upper,” may be utilized to facilitate understanding of one element or feature shown in the drawings as different from another element or feature. The terms related to space are intended to facilitate understanding of the present invention in various states of process or use and are not intended to limit the present invention. For example, if an element or feature in a figure is inverted, an element or feature described as “beneath” or “below” becomes “above” or “upper.” Thus, “beneath” is a concept that encompasses “above” or “below”.

Hereinafter, an all-solid-state battery according to an embodiment of the present invention and an apparatus and method for manufacturing the all-solid-state battery will be described in detail with reference to the accompanying drawings.

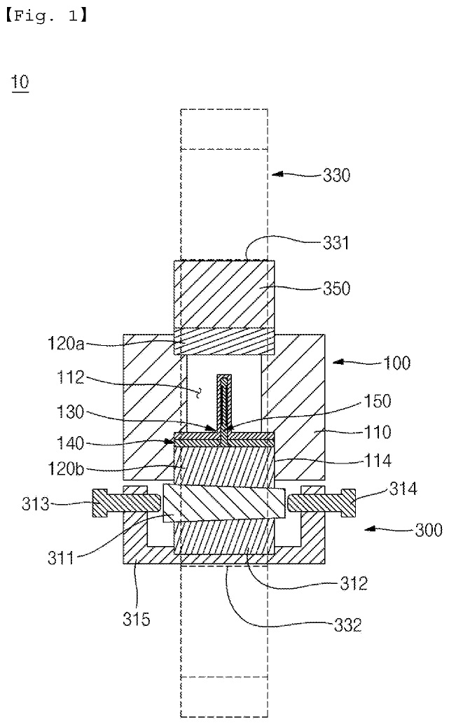

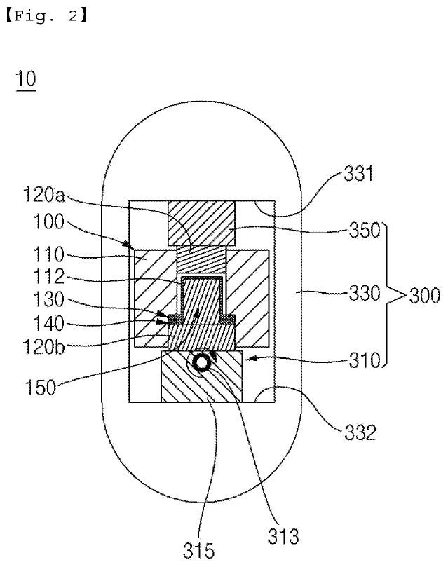

FIG. 1 is a forward sectional view showing an apparatus for manufacturing an all-solid-state battery according to an embodiment of the present invention. FIG. 2 is a lateral sectional view showing the apparatus for manufacturing the all-solid-state battery according to the embodiment of the present invention.

As shown in FIGS. 1 and 2, the apparatus 10 for manufacturing the all-solid-state battery according to the embodiment of the present invention may include a manufacturing unit 100 and a support unit 300 configured to support the manufacturing unit 100.

The manufacturing unit 100 may include a pressure vessel 110 and closing covers 120a and 120b configured to apply pressure and an outer punch 130, an ejecting plate 140, and a die 150 configured to shape a sheet material. The support unit 300 may include a compensation portion 310 configured to compensate for a gap, a support portion 330 configured to support the manufacturing unit 100 from above and below (commonly referred to as a yoke, which is constituted by a yoke-ring and a yoke-block), and a support block 350 inserted between the compensation portion 310 and the support portion 330.

Hereinafter, the structure of the manufacturing unit and a method of manufacturing the all-solid-state battery will be described in detail first.

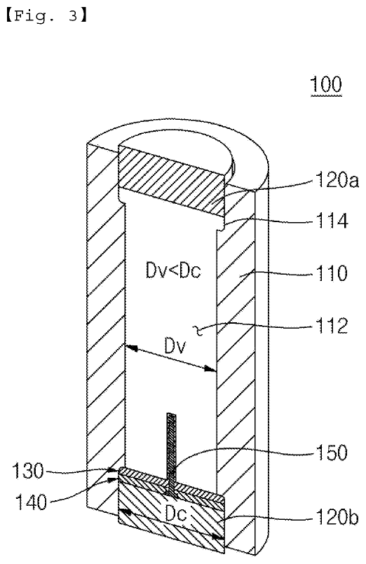

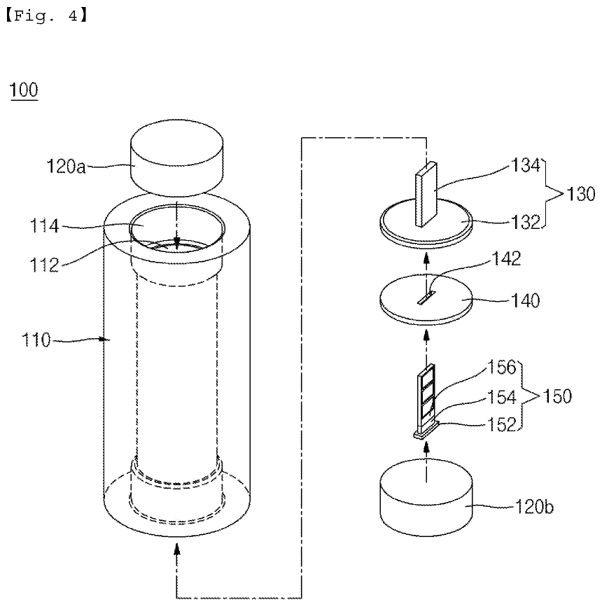

FIG. 3 is a sectional view showing the manufacturing unit of the apparatus for manufacturing the all-solid-state battery according to FIGS. 1 and 2. FIG. 4 is an exploded perspective view showing main parts of the apparatus for manufacturing the all-solid-state battery according to FIG. 3.

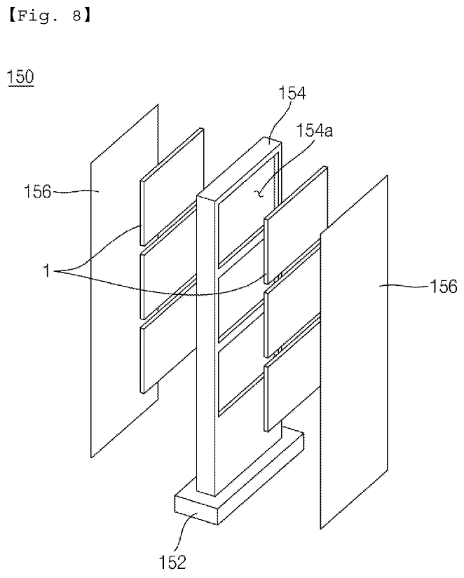

As shown in FIGS. 1 to 4, the apparatus 10 for manufacturing the all-solid-state battery is an apparatus for applying pressure to a sheet material 1 (see FIG. 8), which becomes an electrode of an all-solid-state battery. The manufacturing apparatus 10 may include a pressure vessel 110 and a pair of closing covers 120a and 120b configured to apply pressure and an outer punch 130, an ejecting plate 140, and a die 150 configured to receive and shape the sheet material 1.

For example, the sheet material 1 may include a structure in which a pole plate for all-solid-state batteries and an electrolyte or various buffer films are laminated. That is, the sheet material 1 refers to a material that requires densification through a pressing process at an ultra-high pressure. For example, the sheet material 1 may include a pole plate, an electrolyte, a film, and a plate in order to uniformly distributing pressure on an upper surface and a lower surface of a single-layer or multiple-layer all-solid-state battery. An ordinary method may be used as the lamination method of the sheet material 1.

As shown in FIGS. 3 and 4, the pressure vessel 110 has a cylindrical appearance and a cylindrical inner space penetrated from an upper surface to a lower surface thereof. Cylindrical closing covers 120a and 120b are inserted into an upper part and a lower part of the penetrated inner space, respectively. For example, each of the pressure vessel 110 and the closing covers 120a and 120b may be made of stainless steel. The area excluding a cover insertion portion 114, into which the closing covers 120a and 120b are inserted, may be defined as a pressing portion 112. The pressing portion 112 may be filled with a medium configured to provide ultra-high isobaric pressure to the sheet material 1. In some examples, the medium may be water or oil. In some examples, the inner diameter Dc of the cover insertion portion 114 may be greater than the inner diameter Dv of the pressing portion 112. In the state in which the upper closing cover 120a is mounted to the pressure vessel 110, the outer punch 130 is mounted in the pressure vessel 110, and the lower closing cover 120b having the die 150 and the ejecting plate 140 seated thereon so as to be removable therefrom is partially received in the pressure vessel 110, the pressing portion may be filled with medium. Thereafter, although not shown in the figures, addition or discharge of the medium may be precisely controlled using a pressing pump system configured to move the medium through a pipe installed through the closing covers 120a and 120b or a side surface of the pressure vessel 110. Consequently, pressing the medium filled in the pressing portion 112 to a specific target value of pressure in the state in which the upper and lower closing covers 120a and 120b are fastened may generate a high or ultra-high pressure that presses the sheet material 1. For example, the pressure applied in the pressure vessel 110 may be high or ultra-high pressure within a range of 100 to 700 MPa. The sheet material 1 is disposed in the pressing portion 112 in a state of being received in the punch and the die.

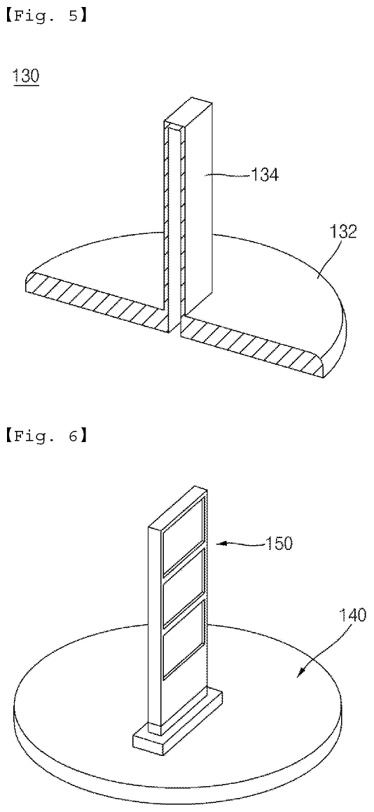

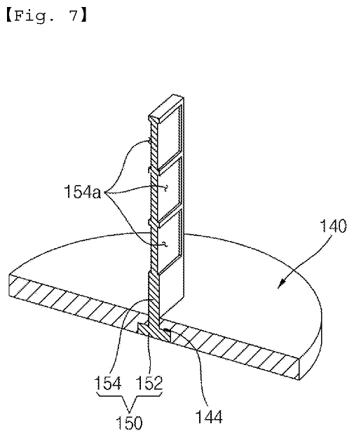

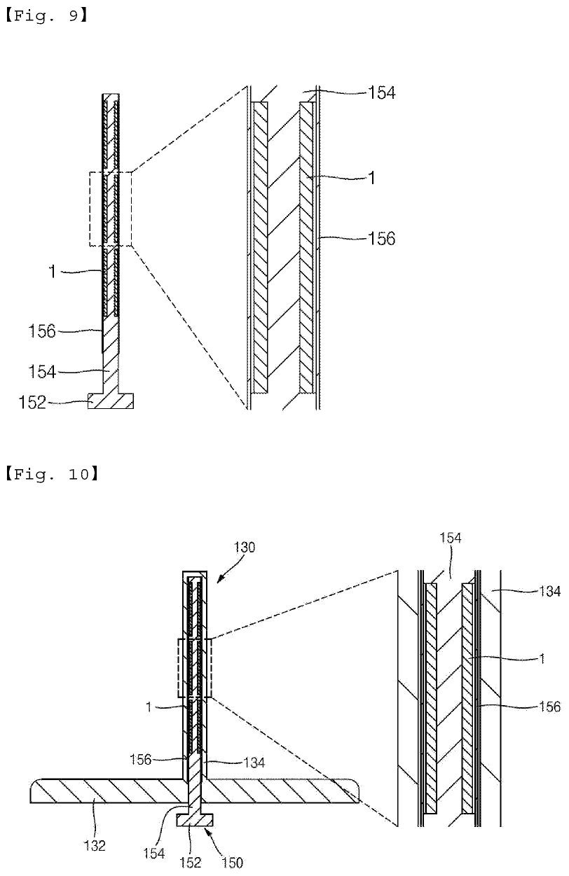

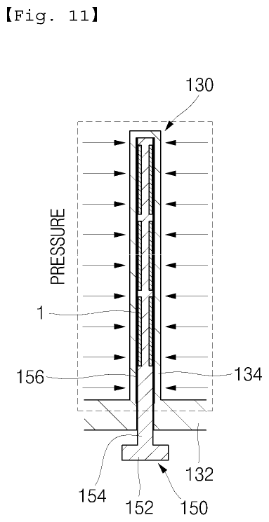

FIG. 5 is a cut perspective view showing the outer punch according to FIG. 4. FIG. 6 is a coupled perspective view showing the ejecting plate and the die according to FIG. 4. FIG. 7 is a cut perspective view of the ejecting plate and the die according to FIG. 6. FIG. 8 is an exploded perspective view of the die according to FIG. 4. FIG. 9 is a sectional view of the die according to FIG. 8. FIG. 10 is a sectional view of the ejecting plate and the die according to FIG. 6. FIG. 11 is a schematic view showing the direction of pressure applied to the main parts according to FIG. 3.

As shown in FIGS. 3 to 5, the outer punch 130 is coupled to the die 150 in the state in which the ejecting plate 140 is interposed therebetween. For example, the outer punch 130 may be made of an elastic material including rubber. The outer punch 130 may include a disc-shaped base plate 132 and a die receiving portion 134 integrally formed at the base plate 132. The base plate 132 may have a predetermined thickness and may have a diameter corresponding to the inner diameter of the cover insertion portion 114 and the diameter Dc of each of the upper and lower closing covers 120a and 120b. The die receiving portion 134 extends upward from an upper surface of the base plate 132, and receives a die plate 154 (see FIGS. 7 and 8) of the die 150. To this end, the die receiving portion 134 may have the shape of a hollow box and may be in communication with a lower surface of the base plate 132. The size and shape of the die receiving portion 134 may correspond to the size and shape of the die plate 154, which will be described later. If the outer punch 130 is inserted into the pressure vessel 110, the die receiving portion 134 is located in the pressing portion 112 in order to shape the sheet material 1 under pressure, and, in the figures, an outside of the die receiving portion 134 and an upper side of the base plate 132 abut the pressing portion 112 so as to contact the medium. However, a side surface and a lower side of the base plate 132 may be located in the cover insertion portion 114. The outer punch 130 may be assembled and fixed to the pressure vessel side using a manufacturing method of conventional isostatic shaping press equipment. The die plate 154 of the die 150, which corresponds to a moving part, is inserted into and mounted in the die receiving portion 134, which corresponds to a stationary part, in the state in which the ejecting plate 140 is interposed therebetween. Then, by pulling the ejecting plate 140 to withdraw the die 150, the die 150 and the sheet material 1 are removed from the die receiving portion 134. In a pressing process for manufacturing an all-solid-state battery proposed by the present invention, the insertion and withdrawal operations are repeated through the die receiving part 134, which is stationary, using a “dry method.”

As shown in FIGS. 4, 6, and 7, the ejecting plate 140 is configured to insert and withdraw the die 150 into and from the outer punch 130. The ejecting plate 140 has a disc shape with a through-hole 142 formed through the center of a plate surface thereof. A cut portion 144 may be formed in a lower surface of the ejecting plate 140 so as to correspond in position to the through-hole 142. The cut portion 144 has a shape corresponding to the shape of a die pad 152 of the die 150, a description of which will follow, and may be cut, for example, in a tapered or stepped shape. For example, based on FIG. 7, the height of the through-hole 142 may correspond to ½ of the thickness of the ejecting plate 140. The thickness of the cut portion 144 may correspond to the remaining ½ of the thickness of the ejecting plate 140. Because the cut portion 144 is provided, the die 150 may be easily separated from the outer punch 130 by pulling the ejecting plate 140. The ejecting plate 140 supports between the outer punch mold 130, which has elasticity, and the closing cover 120b, which is made of steel, during pressing of the sheet material 1. In addition, the ejecting plate 140 performs a support and cushioning function between the closing cover 120b and the die 150, and prevents excessive deformation of the base plate 132. The ejecting plate 140 is not fixed to the pressure vessel 110 or the closing cover 120b, and is repeatedly subjected to simple contact and separation during the pressing process. Because the ejecting plate 140 performs a support and cushioning function and is subjected to frequent contact and separation, the ejecting plate 140 may be made of predetermined durable material. For example, the ejecting plate 140 may be made of a material identical to the material of the closing covers 120a and 120b or the die 150, such as stainless steel, or a material similar to the material thereof.

As shown in FIGS. 4 and 6 to 8, the die 150 may include a die pad 152, a die plate 154 having an intaglio portion 154a configured to be filled with the sheet material 1 and to support the sheet material 1, and a fixing film 156 attached to the die plate 154. The die pad 152 and the die plate 154 may be integrally formed, and the fixing film 156 may be separately provided and attached to the die plate 154. Alternatively, the die pad 152 and the die plate 154 may be formed separately depending on the nature and purpose of the process.

The die pad 152 is a part that is brought into tight contact with the cut portion 144 if the die 150 is inserted into the ejecting plate 140. The die pad 152 is formed in a predetermined size and may have a shape corresponding to the shape of the cut portion 144. The die plate 154 is formed so as to extend upward from the die pad 152.

The die plate 154 is a cuboidal plate having a predetermined size. Based on FIG. 8, the die plate 154 may have an intaglio portion 154a concavely formed in each of left and right plate surfaces thereof. For example, the intaglio portion 154a may be quadrangular and may be formed so as to have a predetermined depth. However, the shape of the intaglio portion 154a is not limited to a simple quadrangle and may basically have a shape corresponding to the outline shape of the sheet material 1 and a step. As an example, a plurality of the intaglio portions 154a may be symmetrically formed in the left and right plate surfaces of the die plate 154. After the intaglio portion 154a is filled with the sheet material 1, the sheet material is densified through a pressing process. In the state in which the intaglio portion 154a is filled with the sheet material 1, the fixing film 156 is attached to prevent the sheet material 1 from being separated from the intaglio portion.

As shown in FIGS. 8 and 9, the fixing film 156 is a film configured to fix the sheet material 1 to the die plate 154, and may be fixed to the die plate 154 using a lamination method or the like. For example, the fixing film 156 may be made of a polymer material such as PE. The fixing film 156 is made of any polymer material that satisfies the characteristics of the intended lamination process, such as adhering to the die 150 above a certain temperature but maintaining a release property that allows the fixing film to be separated well from the sheet material 1. After the fixing film 156 is laminated, the die 150 is inserted into the outer punch 130 in the state in which the die 150 is inserted into the ejecting plate 140.

FIG. 10 shows only the state in which the die 150 and the outer punch 130 are coupled to each other without the ejecting plate 140. As shown in FIG. 10, if the die 150 and the outer punch 130 are coupled to each other, the fixing film 156 and the die receiving portion 134 of the outer punch 130 are sequentially located outside the sheet material 1. If the outer punch 130 is inserted into the pressure vessel 110 in this state, pressure is applied to the die receiving portion 134 of the outer punch 130, as shown in FIG. 11. At this time, the pressure is applied in a direction perpendicular to the plate surface of the die receiving portion 134. By the pressure of the medium applied to the outside of the die receiving portion 134, the inside of the die receiving portion 134 is brought into tight contact with the die plate 154 to uniformly “planarly press” the sheet material 1.

The pressing process of the present embodiment may be defined as a planar pressing process because the pressure is uniformly applied to the entirety of the plate surface of the die receiving portion 134, as described above. In practice, the pressure caused by the medium is applied to the entirety of the outer punch 130, but because the base plate 132 is supported by the closing cover 120b made of steel, effective pressure is not generated or is offset. Thus, only planar pressure perpendicular to the plane of the sheet material 1 becomes an effective pressure. However, a part of the outer punch 130 may be pushed by ultra-high pressure and may be deformed, whereby a structure capable of preventing this is necessary (this will be described later).

In the previous embodiment, the structure in which the diameters of the base plate 132 of the outer punch 130, the ejecting plate 140, and the closing covers 120a and 120b are similar or equal to each other and the diameters thereof are greater than the inner diameter of the pressure vessel 110 has been described by way of example. However, a manufacturing unit having a structure different from the previous embodiment may be provided.

Hereinafter, an apparatus for manufacturing an all-solid-state battery according to another embodiment of the present invention will be described (only the structure different from the previous embodiment will be described).

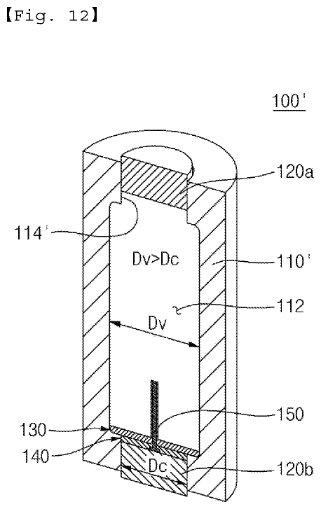

FIG. 12 is a sectional view showing main parts of an apparatus for manufacturing an all-solid-state battery according to another embodiment of the present invention.

As shown in FIG. 12, a manufacturing unit 100′ according to another embodiment of the present invention may be configured such that the inner diameter Dv of a pressing portion 112 of a pressure vessel 110′ is greater than the inner diameter Dc of a cover insertion portion 114′. For example, the diameter of a base plate 132 may correspond to the inner diameter of the pressing portion 112. The diameters of an ejecting plate 140 and closing covers 120a and 120b may correspond to the inner diameter of the cover insertion portion 114′. Although identical in structure and assembly sequence to the previous embodiment, an outer punch 130 is joined to the pressure vessel 110′ in the state in which the outer punch is first inserted into the pressure vessel. Because the outer punch 130 is made of an elastic material, the outer punch may be inserted in a deformed state, or a die receiving portion and the base plate may be separated from the pressure vessel and then the outer punch may be joined to the pressure vessel. Subsequently, the structure in which a die 150, which is a moving part, and a sheet material are inserted into and withdrawn from the die receiving portion of the outer punch 130, which corresponds to a stationary part, is the same as in the previous embodiment.

In the aforementioned embodiments, the sheet material 1 is pressed in the state in which sheet material is received in the die 150 and is inserted into the outer punch 130, whereby the sheet material 1 may be pressed in a dry state. Compared to a wet pressing method, therefore, the pressing process of the sheet material may be simplified and the process time may be shortened. In addition, because a vacuum sealing bag is replaced by a laminating film, the cost of consumable materials may be reduced, thereby reducing the manufacturing cost in the pressing process.

In the apparatus for manufacturing the all-solid-state battery having the aforementioned configuration, the manufacturing unit is supported by a support unit.

Hereinafter, the structure and operation of the support unit will be described in detail.

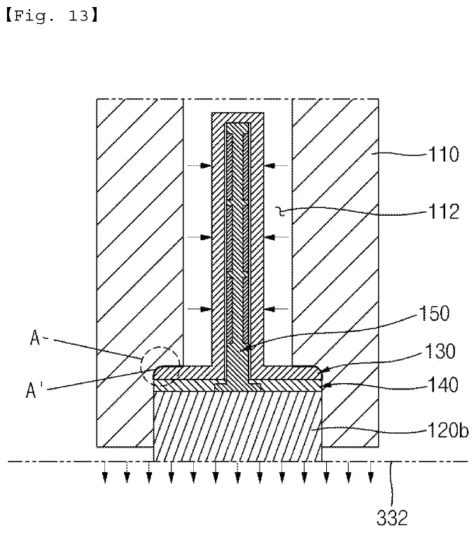

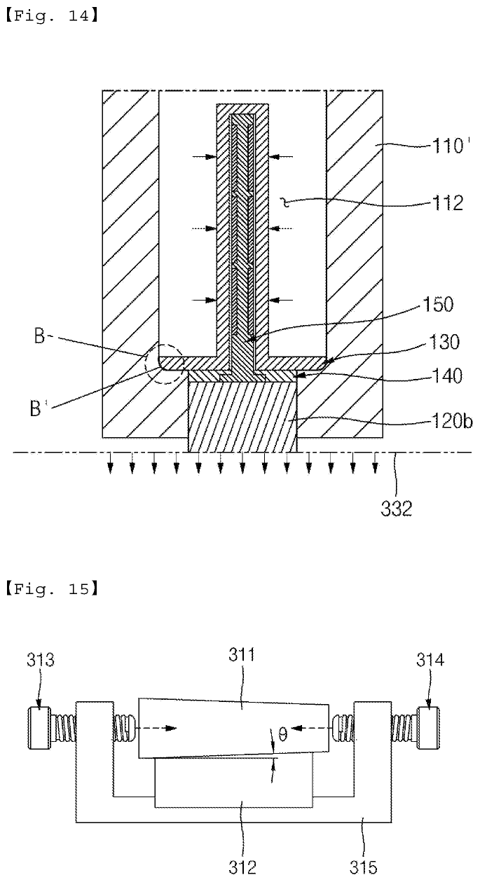

FIG. 13 is a schematic view showing a part of the manufacturing unit according to FIG. 3. FIG. 14 is a schematic view showing a part of the manufacturing unit according to FIG. 12.

The pressure caused by the medium in the pressure vessel 110 is applied in a direction toward an inner circumferential surface of the pressure vessel 110, in a direction toward the base plate 132 of the outer punch 130, and in a direction toward the plate surface of the die receiving portion 134, as shown in FIG. 13. At this time, the pressure is transmitted to the ejecting plate 140 and the closing covers 120a and 120b, whereby the ejecting plate and the closing covers are pushed a certain distance in a downward direction (hereinafter referred to as the amount of pushing). Because the diameter of the base plate 132 of the outer punch 130 is greater than the inner diameter of the pressure vessel 110, the edge (region A) of the base plate 132 is not subjected to direct pressure. At this time, stress may be concentrated on the edge of the base plate 132 that is subjected to a relatively different degree of pressure, especially an upper part A′ of the edge, whereby deformation may occur. In the case of the embodiment according to FIG. 14, stress may be concentrated on a lower part B′ of the edge (region B) of the base plate 132, whereby deformation may occur. Deformation may cause durability issues, such as fatigue failure, and needs to be prevented. To this end, the support unit 300 is provided.

FIG. 15 is a schematic view showing a part of the support unit according to FIGS. 1 and 2.

As shown in FIGS. 1, 2, and 15, the support unit 300 includes a compensation portion 310, a support portion 330, and a support block 350.

The compensation portion 310 is configured to prevent pushing of the ejecting plate 140 and the closing cover 120b in contact with the outer punch 130 and to compensate for the amount of pushing. The compensation portion 310 may include a moving block 311, a guide block 312, an insertion bolt 313, a withdrawal bolt 314, and a support fixture 315.

The moving block 311 is disposed under the closing cover 120b, and is a heavy body having a trapezoidal shape in a sectional view based on FIG. 15. More specifically, the moving block 311 may be trapezoidal in shape formed such that the height of the end toward the insertion bolt 313 (distance between upper and lower surfaces) is greater than the height of the end toward the withdrawal bolt 314. Thus, the upper surface or the lower surface of the moving block 311 is inclined. The moving block 311 may be pushed toward the withdrawal bolt 314 by the insertion bolt 313. As the moving block 311 moves, the height of the moving block 311 gradually increases, whereby the moving block 311 pushes the closing cover 120b upward. Thus, pushing of the outer punch 130, the ejecting plate 140, and the closing cover 120b may be prevented. The guide block 312 is brought into tight contact with a lower part the moving block 311.

The guide block 312 is disposed under the moving block 311. The guide block 312 is a heavy body having an approximately hexahedral shape and having an inclined upper surface based on FIG. 15. More specifically, the guide block 312 may be formed such that the height (distance between upper and lower surfaces) gradually increases from the end toward the insertion bolt 313 to the end toward the withdrawal bolt 314. The lower surface of the guide block 312 is not inclined, and is brought into tight contact with and fixed to an inner bottom surface of the support fixture 315 in parallel thereto. The angle θ between an imaginary reference line parallel to the lower surface of the guide block 312 and the inclined upper surface of the guide block 312 (or the lower surface of the moving block) may be designed in consideration of the amount of pushing described above.

The insertion bolt 313 may be rotatably installed at one side of the support fixture 315, and the withdrawal bolt 314 may be rotatably installed at the other side of the support fixture 315 opposite the insertion bolt 313. For example, the insertion bolt 313 may be disposed at a taller side of the moving block 311 based on FIG. 15, and the withdrawal bolt 314 may be disposed at a shorter side of the moving block 311. If the insertion bolt 313 is rotated, the insertion bolt 313 may move in a straight line in a direction toward the withdrawal bolt 314 and in the opposite direction. If the withdrawal bolt 314 is also rotated, the withdrawal bolt may move in a straight line in a direction toward the insertion bolt 313 and in the opposite direction. Thus, the insertion bolt 313 may be rotated to push the moving block 311 in the direction toward the withdrawal bolt 314. This causes the moving block 311 to gradually increase in height as the moving block moves along the guide block 312 toward the withdrawal bolt 314, whereby the closing cover 120b may be brought into tight contact with the pressure vessel 110. Conversely, the withdrawal bolt 314 may be rotated to push the moving block 311 toward the insertion bolt 313. As a result, the moving block 311 gradually decreases in height as the moving block moves along the guide block 312 toward the insertion bolt 313, whereby a gap is generated between the closing cover 120b and the compensation portion 310. The manufacturing unit 100 may then be separated from the support unit 300.

Although not shown in the figures, for example, a single screw bolt may extend through the moving block 311 from one side to the other side and may be rotatably coupled to opposite side surfaces of the support fixture 315. In this case, rotation of the screw bolt in one direction may move the moving block 311 in an insertion direction of the closing cover 120b, and rotation of the screw bolt in the other direction may move the moving block in a withdrawal direction of the closing cover.

For example, the support fixture 315 may have the shape of a box having an upward opening. The support fixture 315 may receive the moving block 311 and the guide block 312, and the lower surface of the guide block 312 may be fixed to the inner bottom surface of the support fixture. The insertion bolt 313 may be rotatably inserted into one of the side surfaces of the support fixture opposite each other, and the withdrawal bolt 314 may be rotatably inserted into the other side surface of the support fixture. Alternatively, as shown in FIG. 15, the support fixture may be formed so as to have an approximately U sectional shape, not a box shape. Even in this case, the insertion bolt 313 and the withdrawal bolts 314 may be installed at the opposite side surfaces of the support fixture. An outer bottom surface of the support fixture 315 may be fixed to the support portion 330.

Referring to FIGS. 1 and 2, the support portion 330 is shown as an approximately ring-shaped yoke system configured to support the manufacturing unit 100 from above and below, but is not limited thereto. As an example, for small equipment with relatively low pressure, the yoke system may be replaced with a cross bar and a hydraulic unit. The support block 350 may be inserted between an upper part of the manufacturing unit 100 and the support portion 330, and a lower part of the manufacturing unit 100 may be supported by the compensation portion 310. The part in contact with an upper part of the support block 350 is referred to as an upper contact portion 331, and the part in contact with a lower surface of the support fixture 315 of the compensation portion 310 is referred to as a lower contact portion 332. Conventionally, a pair of support blocks 350 is inserted between the support portion 330 and the manufacturing unit 100, but the present embodiments provide a compensation portion 310 capable of compensating for the amount of pushing instead of the lower support block 350.

In a structure in which the compensation portion 310 is not provided, if the closing cover is inserted into the pressure vessel, the support block is inserted into each of the top and the bottom of the pressure vessel, and pressure is applied, the lower part of the support portion may be deformed as the closing cover is pushed firstly, and the outer punch may be greatly deformed as the closing cover is pushed secondly. In the present invention, however, the compensation portion 310 is provided to prevent the closing cover from being pushed.

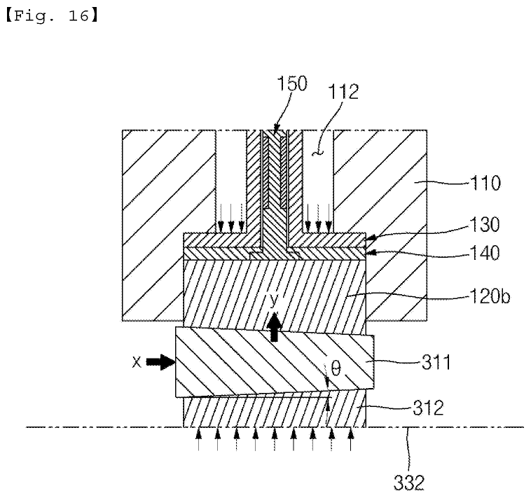

FIG. 16 is a schematic view showing an operating principle of the support unit according to FIGS. 1 and 2 (upward, downward, leftward, and rightward directions are based on FIG. 16).

As shown in FIG. 16, the moving block 311 moves in a straight direction parallel to the lower contact portion 332 of the support block 330. If the closing cover 120b is inserted into the pressure vessel 110, the support block 350 and the compensation portion 310 are inserted, and the insertion bolt 313 is rotated, the moving block 311 moves in an x direction. Because the left and right heights of the moving block 311 are different from each other, the height of the lower closing cover 120b changes according to the linear motion of the moving block 311. That is, if the moving block 311 moves in the x direction (direction toward the withdrawal bolt), the height of the moving block 311 gradually increases, causing the lower closing cover 120b to move upward in a y direction. As the lower closing cover 120b moves upward, the pressing process is performed without the lower closing cover 120b being significantly pushed away from the pressure vessel 110. The opposite upper closing cover 120a, which is not adjacent to the outer punch 130, the ejecting plate 140, and the die 150, may be partially pushed by the pressure as in a conventional manner. As force is applied in a direction opposite the y direction by the pressure, the lower closing cover 120b is pushed. For example, if the amount of pushing is constant and is measured in advance, the amount of pushing may be compensated for in a passive manner in which the moving block 311 is transferred in advance in response to the amount of pushing. Alternatively, if the amount of pushing is not constant and needs to be measured in real time, the amount of pushing may be compensated for in an active automatic control manner in which the amount of pushing is monitored and the moving block 311 is transferred in response to the amount of pushing. For example, a rise value (e.g., in mm) of the closing cover 120b to compensate for the amount of pushing may be calculated by multiplying the movement value (e.g., in mm) of the moving block 311 by sine (y=x×sin θ).

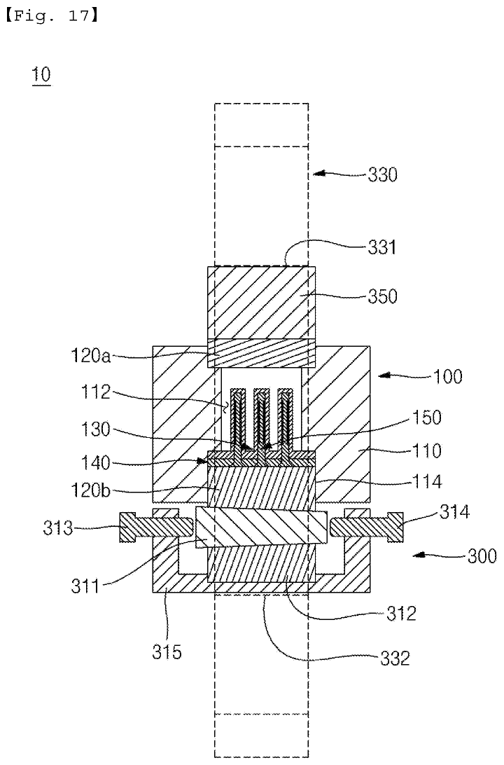

Meanwhile, all-solid-state batteries may be produced in high volume by applying the structure of the aforementioned embodiment. Hereinafter, an all-solid-state battery according to another embodiment of the present invention and an apparatus and method for manufacturing the all-solid-state battery will be described in detail with reference to the accompanying drawings (it should be noted that in some figures, the number of outer punches and dies is reduced for convenience. Also, in the apparatus for manufacturing the all-solid-state battery according to the present embodiment, a manufacturing unit is supported by a support unit. The structure of the support unit is the same as in the previous embodiment, and therefore a detailed description thereof will be omitted. Furthermore, it should be noted that the reference numerals shown in FIGS. 17 to 26 apply only to the configurations referring to FIGS. 17 to 26).

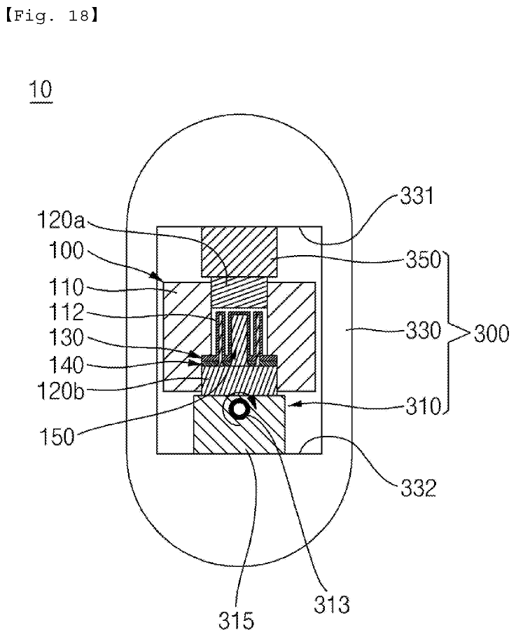

FIG. 17 is a forward sectional view showing an apparatus for manufacturing an all-solid-state battery according to an embodiment of the present invention. FIG. 18 is a lateral sectional view showing the apparatus for manufacturing the all-solid-state battery according to the embodiment of the present invention.

As shown in FIGS. 17 and 18, the apparatus 10 for manufacturing the all-solid-state battery according to the embodiment f the present invention may include a manufacturing unit 100 and a support unit 300 configured to support the manufacturing unit 100.

The manufacturing unit 100 may include a pressure vessel 110 and closing covers 120a and 120b configured to apply pressure and an outer punch 130, an ejecting plate 140, and a die 150 configured to shape a sheet material. The support unit 300 may include a compensation portion 310 configured to compensate for a gap, a support portion 330 configured to support the manufacturing unit 100 from above and below (commonly referred to as a yoke, which is constituted by a yoke-ring and a yoke-block), and a support block 350 inserted between the compensation portion 310 and the support portion 330.

Hereinafter, the structure of the manufacturing unit and a method of manufacturing the all-solid-state battery will be described in detail first.

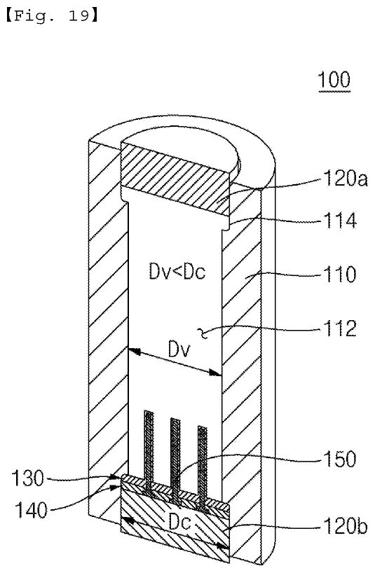

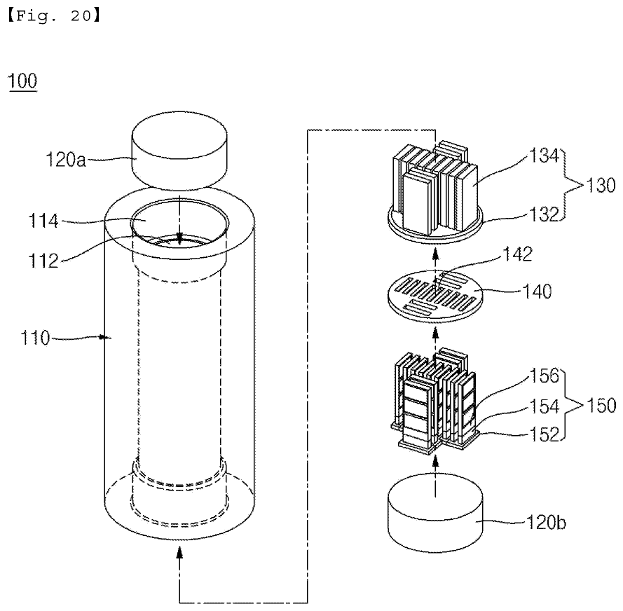

FIG. 19 is a sectional view showing the manufacturing unit of the apparatus for manufacturing the all-solid-state battery according to FIGS. 17 and 18. FIG. 20 is an exploded perspective view showing main parts of the apparatus for manufacturing the all-solid-state battery according to FIG. 19.

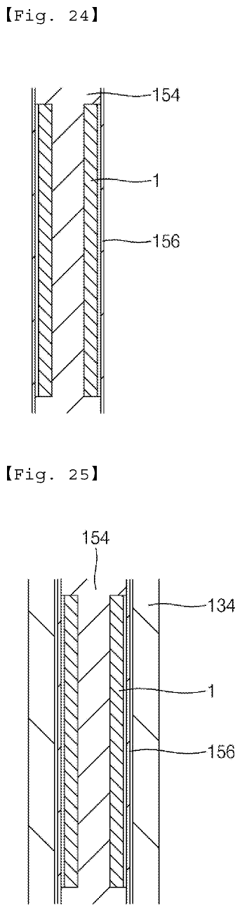

As shown in FIGS. 17 to 20, the apparatus 10 for manufacturing the all-solid-state battery is an apparatus for applying pressure to a sheet material 1 (see FIG. 24), which becomes an electrode of an all-solid-state battery. The manufacturing apparatus 10 may include a pressure vessel 110 and a pair of closing covers 120a and 120b configured to apply pressure and an outer punch 130, an ejecting plate 140, and a die 150 configured to receive and shape the sheet material 1.

For example, the sheet material 1 may include a structure in which a pole plate for all-solid-state batteries and an electrolyte or various buffer films are laminated. That is, the sheet material 1 refers to a material that requires densification through a pressing process at an ultra-high pressure. For example, the sheet material 1 may include a pole plate, an electrolyte, a film, and a plate in order to uniformly distribute pressure on an upper surface and a lower surface of a single-layer or multilayer all-solid-state battery. An ordinary method may be used as the lamination method of the sheet material 1.

As shown in FIGS. 19 and 20, the pressure vessel 110 has a cylindrical appearance and a cylindrical inner space penetrated from an upper surface to a lower surface thereof. Cylindrical closing covers 120a and 120b are inserted into an upper part and a lower part of the penetrated inner space, respectively. For example, each of the pressure vessel 110 and the closing covers 120a and 120b may be made of stainless steel. The area excluding a cover insertion portion 114, into which the closing covers 120a and 120b are inserted, may be defined as a pressing portion 112. The pressing portion 112 may be filled with a medium configured to provide ultra-high isobaric pressure to the sheet material 1. In some examples, the medium may be water or oil. In some examples, the inner diameter Dc of the cover insertion portion 114 may be greater than the inner diameter Dv of the pressing portion 112. In the state in which the upper closing cover 120a is mounted to the pressure vessel 110, the outer punch 130 is mounted in the pressure vessel 110, and the lower closing cover 120b having the die 150 and the ejecting plate 140 seated thereon so as to be removable therefrom is partially received in the pressure vessel 110, the pressing portion may be filled with medium. Thereafter, although not shown in the figures, addition or discharge of the medium may be precisely controlled using a pressing pump system configured to move the medium through a pipe installed through the closing covers 120a and 120b or a side surface of the pressure vessel 110. Consequently, pressing the medium filled in the pressing portion 112 to a specific target value of pressure in the state in which the upper and lower closing covers 120a and 120b are fastened may generate a high or ultra-high pressure that presses the sheet material 1. For example, the pressure applied in the pressure vessel 110 may be high or ultra-high pressure within a range of 100 to 700 MPa. The sheet material 1 is disposed in the pressing portion 112 in a state of being received in the punch and the die.

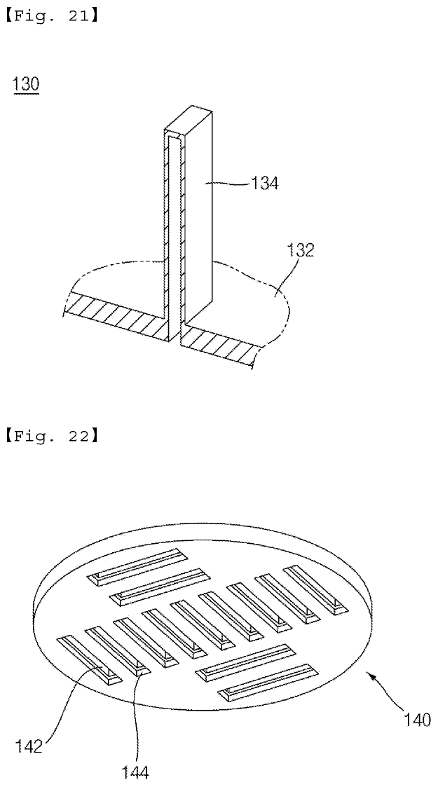

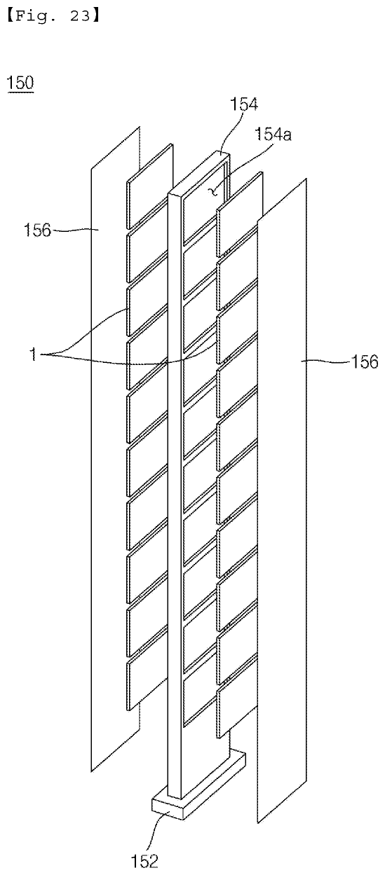

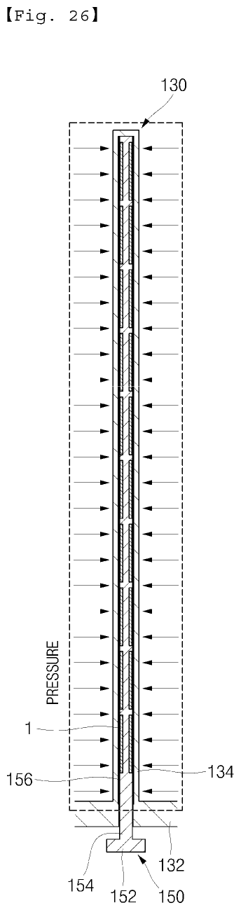

FIG. 21 is a cut perspective view showing a part of the outer punch according to FIG. 20. FIG. 22 is a perspective view showing the ejecting plate according to FIG. 20. FIG. 23 is an exploded perspective view of the die according to FIG. 20. FIG. 24 is a partial sectional view of the die according to FIG. 23. FIG. 25 is a partial sectional view of the die and the outer punch according to FIG. 20. FIG. 26 is a schematic view showing the direction of pressure applied to the main parts according to FIG. 19.

As shown in FIGS. 19 to 21, the outer punch 130 is coupled to the die 150 in the state in which the ejecting plate 140 is interposed therebetween. For example, the outer punch 130 may be made of an elastic material including rubber. The outer punch 130 may include a disc-shaped base plate 132 and a plurality of die receiving portions 134 integrally formed at the base plate 132.

The base plate 132 may have a predetermined thickness and may have a diameter corresponding to the inner diameter of the cover insertion portion 114 and the diameter Dc of each of the upper and lower closing covers 120a and 120b.

The die receiving portion 134 extends upward from an upper surface of the base plate 132, and receives a die plate 154 (see FIG. 7) of the die 150. To this end, the die receiving portion 134 may have the shape of a hollow box and may be in communication with a lower surface of the base plate 132. The plurality of die receiving portions 134 may be disposed spaced apart from each other by a predetermined distance so as not to overlap each other. The size and shape of the die receiving portion 134 may correspond to the size and shape of the die plate 154, which will be described later. In addition, the number of die receiving portions 134 may correspond to the number of die plates 154.

If the outer punch 130 is inserted into the pressure vessel 110, the die receiving portion 134 is located in the pressing portion 112 in order to shape the sheet material 1 under pressure, and, in the figures, an outside of the die receiving portion 134 and an upper side of the base plate 132 abut the pressing portion 112 so as to contact the medium. However, a side surface and a lower side of the base plate 132 may be located in the cover insertion portion 114. The outer punch 130 may be assembled and fixed to the pressure vessel side using a manufacturing method of conventional isostatic shaping press equipment. The die plate 154 of the die 150, which corresponds to a moving part, is inserted into and mounted in the die receiving portion 134, which corresponds to a stationary part, in the state in which the ejecting plate 140 is interposed therebetween. Then, by pulling the ejecting plate 140 to withdraw the die 150, the die 150 and the sheet material 1 are removed from the die receiving portion 134. In a pressing process for manufacturing an all-solid-state battery proposed by the present invention, the insertion and withdrawal operations are repeated through the die receiving part 134, which is stationary, using a “dry method.”

As shown in FIGS. 21 and 22, the ejecting plate 140 is configured to insert and withdraw the die 150 into and from the outer punch 130. The ejecting plate 140 has a disc shape with a plurality of through-holes 142 formed through a plate surface thereof. The position and the number of the through-holes 142 may correspond to the position and the number of the die receiving portions 134 of the outer punches 130. A cut portion 144 may be formed in a lower surface of the ejecting plate 140 so as to correspond in position to the through-hole 142. The cut portion 144 has a shape corresponding to the shape of a die pad 152 of the die 150, a description of which will follow, and may be cut in a tapered or stepped shape. Because the cut portion 144 is provided, the plurality of dies 150 may be easily separated from the plurality of outer punches 130 at once by pulling the ejecting plate 140. The ejecting plate 140 supports between the outer punch mold 130, which has elasticity, and the closing cover 120b, which is made of steel, during pressing of the sheet material 1. In addition, the ejecting plate 140 performs a support and cushioning function between the closing cover 120b and the die 150, and prevents excessive deformation of the base plate 132. The ejecting plate 140 is not fixed to the pressure vessel 110 or the closing cover 120b, and is repeatedly subjected to simple contact and separation during the pressing process. Because the ejecting plate 140 performs a support and cushioning function and is subjected to frequent contact and separation, the ejecting plate 140 may be made of a predetermined durable material. For example, the ejecting plate 140 may be made of a material similar to the material of the closing covers 120a and 120b or the die 150 or a material identical to the material thereof, such as steel.

As shown in FIGS. 20 and 22 to 24, the die 150 may include a die pad 152, a die plate 154 having an intaglio portion 154a configured to be filled with the sheet material 1 and to support the sheet material 1, and a fixing film 156 attached to the die plate 154. The die pad 152 and the die plate 154 may be integrally formed or may be formed separately depending on the nature and purpose of the process. The fixing film 156 may be separately provided and attached to the die plate 154.

The die pad 152 is a part that is brought into tight contact with the cut portion 144 if the die 150 is inserted into the ejecting plate 140. The die pad 152 is formed in a predetermined size and may have a shape corresponding to the shape of the cut portion 144. The die plate 154 is formed so as to extend upward from the die pad 152.

The die plate 154 is a cuboidal plate having a predetermined size. A plurality of die plates 154 may be provided, and may be formed so as to correspond to the number and the shape of the die receiving portions 134 of the outer punches 130. Based on FIG. 7, the die plate 154 may have an intaglio portion 154a concavely formed in each of left and right plate surfaces thereof. The intaglio portion 154a is configured to be filled with the sheet material 1 and to support the sheet material. For example, the intaglio portion 154a may be quadrangular and may be formed so as to have a predetermined depth. The shape of the intaglio portion 154a is not limited to a quadrangle. That is, the shape of the intaglio portion 154a is not limited to a specific shape as long as the intaglio portion basically has a shape corresponding to the outline shape of the sheet material 1 and a step. As an example, a plurality of the intaglio portions 154a may be symmetrically formed in the left and right plate surfaces of the die plate 154. After the intaglio portion 154a is filled with the sheet material 1, the sheet material is densified through a pressing process. In the state in which the intaglio portion 154a is filled with the sheet material 1, the fixing film 156 is attached to prevent the sheet material 1 from being separated from the intaglio portion.

As shown in FIGS. 23 and 24, the fixing film 156 is a film configured to fix the sheet material 1 to the die plate 154, and may be fixed to the die plate 154 using a lamination method or the like. For example, the fixing film 156 may be made of a polymer material such as PE. The fixing film 156 must adhere to the die 150 above a certain temperature but must retain a release property that allows the fixing film to be separated well from the sheet material 1. Thus, the fixing film 156 may be made of any polymer material that satisfies the characteristics of the lamination process. After the fixing film 156 is laminated, the die 150 is inserted into the outer punch 130 in the state in which the die 150 is inserted into the ejecting plate 140.

FIG. 25 is an enlarged view showing the intaglio portion 154a in the state in which the die 150 and the outer punch 130 are coupled to each other without the ejecting plate 140. As shown in FIG. 25, if the die 150 and the outer punch 130 are coupled to each other, the fixing film 156 and the die receiving portion 134 of the outer punch 130 are sequentially located outside the sheet material 1. If the outer punch 130 is inserted into the pressure vessel 110 in this state, pressure is applied to the die receiving portion 134 of the outer punch 130, as shown in FIG. 10. At this time, the pressure is applied in a direction perpendicular to the plate surface of the die receiving portion 134. By the pressure of the medium applied to the outside of the die receiving portion 134, the inside of the die receiving portion 134 is brought into tight contact with the die plate 154 to uniformly “planarly press” the sheet material 1.

The pressing process of the present embodiment may be defined as a planar pressing process because the pressure is uniformly applied to the entirety of the plate surface of the die receiving portion 134, as described above. In practice, the pressure caused by the medium is applied to the entirety of the outer punch 130, but because the base plate 132 is supported by the closing cover 120b made of steel, effective pressure is not generated or is offset. Thus, only planar pressure perpendicular to the plane of the sheet material 1 becomes an effective pressure. However, a part of the outer punch 130 may be pushed by ultra-high pressure and may be deformed, whereby a structure capable of preventing this is necessary (this will be described later).

In the aforementioned embodiment, the sheet material 1 is pressed in the state in which sheet material is received in the die 150 and is inserted into the outer punch 130, whereby the sheet material 1 may be pressed in a dry state. Compared to a wet pressing method, therefore, the pressing process of the sheet material may be simplified and the process time may be shortened. In addition, because a vacuum sealing bag is replaced by a laminating film (fixing film), the cost of consumable materials may be reduced, thereby reducing the manufacturing cost in the pressing process.

1. An apparatus for manufacturing an all-solid-state battery, the apparatus comprising:
a pressure vessel having a receiving space defined therein, the receiving space being configured to receive a medium;
a pair of closing covers configured to open and close the pressure vessel;
an outer punch configured such that a part or the entirety of the outer punch is received in the pressure vessel; and
a die configured to be inserted into the outer punch in a state in which a plurality of sheet materials is received therein, wherein
a surface of each of the sheet materials, a plate surface of the die in which the sheet materials are received, and a plate surface of the outer punch in which the die is received are parallel to each other,
the outer punch is disposed such that an outside of the outer punch is in contact with the medium, and
the die is disposed between the outer punch and the closing covers so as not to be in contact with the medium.

2. The apparatus as claimed in claim 1, wherein the outer punch comprises:
a disc-shaped base plate; and
a die receiving portion formed so as to extend from the base plate in a plate shape, the die receiving portion being configured to receive the die.

3. The apparatus as claimed in claim 2, wherein the die comprises:
a die plate having a plurality of intaglio portions concavely formed in a plate surface thereof, the intaglio portions being configured to allow the sheet materials to be inserted thereinto;
a die pad configured to support the die plate; and
a fixing film coupled to the die plate in a state in which the sheet materials are inserted into the intaglio portions,
the die plate being inserted into the die receiving portion.

4. The apparatus as claimed in claim 3, further comprising:
a disc-shaped ejecting plate having a through-hole formed therethrough, the through-hole being configured to allow the die plate to be inserted therethrough, wherein
the ejecting plate is disposed between the base plate of the outer punch and the die pad of the die.

5. The apparatus as claimed in claim 4, wherein the ejecting plate comprises a cut portion formed in a surface thereof facing the die pad, the cut portion being cut so as to have a shape corresponding to a shape of the die pad.

6. The apparatus as claimed in claim 4, wherein
the pressure vessel has a cylindrical shape, and
the pressure vessel comprises:
a pressing portion configured to receive the medium; and
cover insertion portions formed at opposite ends of the cylindrical shape, the cover insertion portions communicating with the pressing portion, the cover insertion portions being configured to allow the closing covers to be coupled thereto.

7. The apparatus as claimed in claim 6, wherein
an inner diameter of the pressing portion is less than a diameter of each of the closing covers, and
a diameter of each of the base plate and the ejecting plate corresponds to the diameter of each of the closing covers.

8. The apparatus as claimed in claim 6, wherein
an inner diameter of the pressing portion is greater than a diameter of each of the closing covers,
a diameter of the base plate corresponds to the inner diameter of the pressing portion, and
a diameter of the ejecting plate corresponds to the diameter of each of the closing covers.

9. The apparatus as claimed in claim 1, further comprising a support unit comprising:
a compensation portion disposed under the pressure vessel, the compensation portion being configured to push the closing cover toward the pressure vessel during a pressing process;
a support block disposed above the pressure vessel; and
a support portion configured to support the compensation portion and the support block.

10. The apparatus as claimed in claim 9, wherein the compensation portion comprises:
a moving block disposed under the closing cover;
a guide block disposed under the moving block, the guide block being configured to support the moving block;
a support fixture coupled to the guide block, the support fixture being configured to support the guide block;
an insertion bolt rotatably installed at one side of the support fixture, the insertion bolt being configured to move the moving block in one direction; and
a withdrawal bolt rotatably installed at the other side of the support fixture so as to be opposite the insertion bolt, the withdrawal bolt being configured to move the moving block in a direction toward the insertion bolt.

11. The apparatus as claimed in claim 10, wherein
an upper surface or a lower surface of the moving block is inclined, and
a height of the moving block gradually decreases from an end toward the insertion bolt to an end toward the withdrawal bolt.

12. The apparatus as claimed in claim 11, wherein
an upper surface of the guide block is inclined, and
a height of the guide block gradually increases from an end toward the insertion bolt to an end toward the withdrawal bolt.

13. A method of manufacturing an all-solid-state battery, the method comprising:
inserting a sheet material into each of a plurality of intaglio portions of a die plate and coupling a fixing film to the die plate;
inserting the die plate into a die receiving portion of an outer punch;
inserting the outer punch into a pressure vessel and inserting a lower closing cover into a lower part of the pressure vessel so as to be in tight contact with a base plate of the outer punch and an ejecting plate;
filling the pressure vessel with a medium in a state in which an upper closing cover and the lower closing cover are inserted into the pressure vessel and further pumping the medium through a pipe separately connected to the pressure vessel or to the closing cover to perform pressing; and
moving a moving block to bring the lower closing cover into tight contact with the pressure vessel and performing a pressing process.

14. The method as claimed in claim 13, wherein, in the step of performing pressing, the moving block is moved by a displacement of the lower closing cover pushed by pressure during pressing in order to compensate for the displacement.

15. The method as claimed in claim 13, wherein a surface of the sheet material, a plate surface of the die plate in which the sheet material is received, and a plate surface of the die receiving portion in which the die is received are parallel to each other.

16. The method as claimed in claim 15, wherein
the outer punch is disposed such that an outside of the outer punch is in contact with the medium, and
the die is disposed between an inside of the outer punch and the closing covers so as not to be in contact with the medium.

17. An all-solid-state battery manufactured using the method as claimed in claim 13.

18. An apparatus for manufacturing an all-solid-state battery, the apparatus comprising:
a pressure vessel having a receiving space defined therein, the receiving space being configured to receive a medium;
a pair of closing covers configured to open and close the pressure vessel;
an outer punch configured such that a part or the entirety of the outer punch is received in the pressure vessel, the outer punch comprising a base plate and a plurality of die receiving portions formed so as to extend from the base plate in a plate shape, each of the die receiving portions being configured to receive a die; and
a plurality of dies configured such that each of the dies is inserted into a corresponding one of the die receiving portions in a state in which a plurality of sheet materials is received therein, wherein
a surface of each of the sheet materials, a plate surface of the die in which the sheet materials are received, and a plate surface of the outer punch in which the die is received are parallel to each other,
the outer punch is disposed so as to be in contact with the medium, and
the die is disposed between the outer punch and the closing covers so as not to be in contact with the medium.

19. The apparatus as claimed in claim 18, wherein the plurality of die receiving portions is disposed spaced apart from each other so as not to overlap each other.

20. The apparatus as claimed in claim 19, wherein the die comprises:
a die plate having a plurality of intaglio portions concavely formed in a plate surface thereof, the intaglio portions being configured to allow the sheet materials to be inserted thereinto;
a die pad configured to support the die plate; and
a fixing film coupled to the die plate in a state in which the sheet materials are inserted into the intaglio portions,
the die plate being inserted into the die receiving portion.

21. The apparatus as claimed in claim 20, further comprising:
a disc-shaped ejecting plate having a plurality of through-holes formed therethrough, each of the through-holes being configured to allow the die plate to be inserted therethrough, wherein
the ejecting plate is disposed between the base plate of the outer punch and the die pad of the die.

22. The apparatus as claimed in claim 21, wherein the ejecting plate comprises a cut portion formed in a surface thereof facing the die pad, the cut portion being cut so as to have a shape corresponding to a shape of the die pad.

23. The apparatus as claimed in claim 21, wherein
the pressure vessel has a cylindrical shape, and
the pressure vessel comprises:
a pressing portion configured to receive the medium; and
cover insertion portions formed at opposite ends of the cylindrical shape, the cover insertion portions communicating with the pressing portion, the cover insertion portions being configured to allow the closing covers to be coupled thereto.

24. The apparatus as claimed in claim 23, wherein
an inner diameter of the pressing portion is less than a diameter of each of the closing covers, and
a diameter of each of the base plate and the ejecting plate corresponds to the diameter of each of the closing covers.

25. The apparatus as claimed in claim 18, further comprising a support unit comprising:
a compensation portion disposed under the pressure vessel, the compensation portion being configured to push the closing cover toward the pressure vessel during a pressing process;
a support block disposed above the pressure vessel; and
a support portion configured to support the compensation portion and the support block.

26. The apparatus as claimed in claim 25, wherein the compensation portion comprises:
a moving block disposed under the closing cover;
a guide block disposed under the moving block, the guide block being configured to support the moving block;
a support fixture coupled to the guide block, the support fixture being configured to support the guide block;
an insertion bolt rotatably installed at one side of the support fixture, the insertion bolt being configured to move the moving block in one direction; and
a withdrawal bolt rotatably installed at the other side of the support fixture so as to be opposite the insertion bolt, the withdrawal bolt being configured to move the moving block in a direction toward the insertion bolt.

27. The apparatus as claimed in claim 26, wherein
an upper surface or a lower surface of the moving block is inclined, and
a height of the moving block gradually decreases from an end toward the insertion bolt to an end toward the withdrawal bolt.

28. The apparatus as claimed in claim 27, wherein
an upper surface of the guide block is inclined, and
a height of the guide block gradually increases from an end toward the insertion bolt to an end toward the withdrawal bolt.

29. A method of manufacturing an all-solid-state battery, the method comprising:
inserting a sheet material into each of a plurality of intaglio portions of a die plate and coupling a fixing film to the die plate;
inserting the die plate into each of a plurality of die receiving portions of an outer punch;
inserting the outer punch into a pressure vessel and inserting a lower closing cover into a lower part of the pressure vessel so as to be in tight contact with a base plate of the outer punch and an ejecting plate;
filling the pressure vessel with a medium in a state in which an upper closing cover and the lower closing cover are inserted into the pressure vessel and further pumping the medium through a pipe separately connected to the pressure vessel or to the closing cover to perform pressing; and
moving a moving block to bring the lower closing cover into tight contact with the pressure vessel and performing a pressing process.

30. The method as claimed in claim 29, wherein a surface of the sheet material, a plate surface of the die plate in which the sheet material is received, and a plate surface of the die receiving portion in which the die is received are parallel to each other.

31. The method as claimed in claim 30, wherein
the outer punch is disposed so as to be in contact with the medium, and
the die is disposed between the outer punch and the closing covers so as not to be in contact with the medium.

32. The method as claimed in claim 29, wherein, in the step of performing the pressing process, the moving block is moved by a displacement of the lower closing cover pushed by pressure during pressing in order to compensate for the displacement.

33. An all-solid-state battery manufactured using the method as claimed in claim 29.
